(19) United States
(12) Patent Application Publication
(10) Pub. No.: US 2011/0214566 A1
(43) Pub. Date: Sep. 8, 2011

(54) CARBON DIOXIDE ABSORBENTS

(75) Inventors: Ki Chun Lee, Seoul (KR); Sung Yeup Chung, Seoul (KR)

(73) Assignees: HYUNDAI MOTOR COMPANY, Seoul (KR); KIA MOTORS CORPORATION, Seoul (KR)

(21) Appl. No.: 12/775,010

(22) Filed: May 6, 2010

(30) Foreign Application Priority Data
Mar. 2, 2010 (KR) 10-2010-0018512

(51) Int. Cl. B01D 53/14; C09K 3/00

(52) U.S. Cl. 95/173; 252/184

(57) ABSTRACT

The present invention relates to a carbon dioxide absorbent. In particular, the present invention relates to a carbon dioxide absorbent comprising an ionic liquid, amine and glycol. Since the carbon dioxide absorbent of the present invention can retain excellent CO₂ absorption capacity despite repetitive regenerations at low temperature, it can reduce energy consumption and a loss of absorbents used, and therefore, can be effectively used for a process of collecting carbon dioxide from exhaust gas and natural gas and separating the same.

### CROSS-REFERENCE TO RELATED APPLICATION

This application claims under 35 U.S.C. §119(a) the benefit of Korean Patent Application No. 10-2010-0018512 filed Mar. 2, 2010, the entire contents of which are incorporated herein by reference.

### TECHNICAL FIELD

The present invention relates to a carbon dioxide (CO₂) absorbent. Since the carbon dioxide absorbent of the present invention can retain excellent CO₂ absorption capacity in spite of repetitive regenerations at low temperature, it can reduce energy consumption and the loss of absorbent in the separation process of carbon dioxide.

### BACKGROUND ART

Carbon dioxide inevitably discharged in the course of fossil fuel consumption is a representative greenhouse gas. As the global warming problem has been on the rise as a matter of international concern, it has been endeavored to develop a method for controlling its discharge amount. Accordingly, various attempts have been made to develop methods for acquiring high-efficient energy from the consumption of the same amount of fossil fuels. Further, the development of a method for decreasing the discharge amount of carbon dioxide from industrial facilities by collecting it and recycling thus collected carbon dioxide.

At present, there are several methods used for the separation of carbon dioxide from natural gas and exhaust gas from iron foundries, chemical factories, power plants and large size boilers, for example, as an absorption method, an adsorption method, a separation membrane method and the like. In particular, since the absorption method can treat a large amount of exhaust gas while showing high CO₂ removal efficiency even at a discharge concentration of carbon dioxide from about 8 to 20 vol %, it has been reported to show higher economical efficiency or easier process applicability than other recovery techniques such as an adsorption method or a separation membrane method.

The method of using alkanol amine as a carbon dioxide absorbent has been developed a long time ago and was patented in Unites States in the 1930's. At the beginning, triethanolamine was used as an absorbent. Recently, there have been developed many amine-based absorbents such as monoethanolamine, diethanolamine, methyldiethanolamine, diisopropylamine, piperazine, 2-piperidinemethanol, hydroxylethylpiperazine, 2-amino-2-methyl-1-propanol, 2-ethylaminoethanol, 2-methylaminoethanol, 2-diethylaminoethanol and the like. These amine-based absorbents are commonly used in admixture with a solvent such as water at a concentration from 20 to 50 wt %.

An amine solution as a chemical absorbent having a strong affinity for carbon dioxide absorbs carbon dioxide included in exhaust gases which are fed into an absorber, and the absorbent containing a large amount of carbon dioxide is heated in the course of process, thereby separating into the amine solution and carbon dioxide. Thus separated highly pure carbon dioxide is stored in different storages, the regenerated amine solution is cooled down at a heat exchanger, followed by circulating to the absorber. Carbon dioxide can be separated and recovered by repeating such a series of circulation processes.

However, this process has a serious problem in that it is necessary to provide a large amount of energy for the regeneration of an absorbent by heating it to high temperature so as to break a chemical bond between the amine-based absorbent and carbon dioxide. Further, there is a risk of degrading the absorbent due to high temperature during the regeneration process, which results in the deterioration of CO₂ absorption capacity of the absorbent. Therefore, in order to constantly maintain CO₂ absorption capacity over the whole process, a system for continuously replacing the certain amount of the regenerated absorbent by a new absorbent is needed. Generally, the energy expense accounts for 55% of the total cost for recovering carbon dioxide according to a chemical absorption method, and the cost for regenerating the carbon dioxide absorbent accounts for 80% or more of the energy expense. In addition, the costs for purchasing a new carbon dioxide absorbent, employing and disposing the same account for 15% or more of the total cost for separating and recovering carbon dioxide. Therefore, in order to decrease the cost for recovering carbon dioxide, it is necessary to develop a method for saving the amount of energy used in the regeneration process of an absorbent and reducing the amount of the absorbent used therein.

As a solution for overcoming the problems of such amine-based absorbents, there have been attempted several methods of using an ionic liquid as a carbon dioxide absorbent which is non-volatile, has high thermal-stability and is in the liquid state below 100° C. (U.S. Patent Publication No. 2005-0169825 and U.S. Pat. No. 7,459,134). The ionic liquid is a polar salt compound which is comprised of an organic cation and an inorganic anion. The solubility of a gas dissolved in the ionic liquid varies depending on the degree of the relationship between the gas and ionic liquid. Thus, if polarity, acidity, basicity and nucleophilicity of the ionic liquid are changed by modifying the cation and anion thereof properly, it is possible to control somewhat the solubility of a certain gas. Representative examples of the ionic liquid include compounds that are comprised of organic cations containing a nitrogen such as quaternary ammonium cations including imidazolium, pyrazolium triazolium, pyridinium, pyridazinium, pyrimidinium and the like, and anions including halogens (such as Cl⁻, Br⁻ or I⁻), BF₄⁻, PF₆⁻, (CF₃SO)₂N⁻, CF₃SO₃⁻, MeSO₃⁻, NO₃⁻, CF₃CO₂⁻, CH₃CO₂⁻ and the like. In particular, it has been reported that when the cation includes a fluorine ion, the ionic liquid shows relatively high CO₂ absorption capacity. However, these ionic liquid absorbents have the problems of lower CO₂ absorption capacity at low pressure (1 to 15 atm) than the amine-based absorbents and excessively high manufacturing cost.

The present inventors have therefore endeavored to overcome the problems described above, and found that when the ionic liquid and amine are used by mixing with glycol as a solvent, it is possible to solve the problems of excessive energy consumption in the course of the regeneration process and low thermal-stability of the prior art amine-based absorbents, as well as the problem of low CO₂ absorption capacity of the prior art ionic liquid absorbents at low pressure.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

An object of the present invention is to provide a carbon dioxide absorbent which has high thermal stability and excellent CO₂ absorbing capacity under low pressure and is capable of being regenerated at low temperature.

An aspect of the present invention provides a carbon dioxide absorbent comprising an ionic liquid, an amine and a glycol.

Another aspect of the present invention privies a process of absorbing carbon dioxide using the carbon dioxide absorbent.

The carbon dioxide absorbent of the present invention can significantly reduce energy consumption required for an absorbent regeneration process due to its lower regeneration temperature than the prior art amine-based absorbents, and its high stability allows to considerably decrease the amount of an absorbent used. Further, since it shows superior CO₂ absorbing capacity to the case of using an ionic liquid alone, the carbon dioxide absorbent of the present invention can be effectively used for a process of collecting and separating carbon dioxide from exhaust gas and natural gas generated from the use of fossil fuels.

The above and other aspects and features of the invention will be discussed in detail.

### BRIEF DESCRIPTION OF DRAWINGS

FIG. 1 is a diagram schematically illustrating an evaluation apparatus of absorbing and degassing carbon dioxide.

FIG. 2 is a graph showing the amount of carbon dioxide (40° C., 7 atm) absorbed by 100 wt % MEA while repetitively regenerating at a regeneration temperature of 80° C.

FIG. 3 is a graph showing the amount of carbon dioxide (40° C., 7 atm) absorbed by 30 wt % MEA+70 wt % water while repetitively regenerating at a regeneration temperature of 80° C.

FIG. 4 is a graph showing the amount of carbon dioxide (40° C., 7 atm) absorbed by 30 wt % MEA+70 wt % EG while repetitively regenerating at a regeneration temperature of 80° C.

FIG. 5 is a graph showing the amount of carbon dioxide (40° C., 7 atm) absorbed by 30 wt % MEA+70 wt % [DMIM][MHPO₃] while repetitively regenerating at a regeneration temperature of 80° C.

FIG. 6 is a graph showing the amount of carbon dioxide (40° C., 7 atm) absorbed by 20 wt % [DMIM][MHPO₃]+30 wt % MEA+50 wt % EG while repetitively regenerating at a regeneration temperature of 80° C.

FIG. 7 is a graph showing the amount of carbon dioxide (40° C., 7 atm) absorbed by 5 wt % [EMIM][EtSO₄]+30 wt % DEA+65 wt % EG; 10 wt % [EMIM][EtSO]+30 wt % DEA+60 wt % EG; and 20 wt % [EMIM][EtSO]+30 wt % DEA+50 wt % EG while increasing the number of the regeneration process and gradually elevating a regeneration temperature from 60, 70, 80 to 90° C.

### DETAILED DESCRIPTION OF THE DISCLOSURE

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

In one aspect, the present invention provides a carbon dioxide absorbent in which an ionic liquid and am amine are mixed with a glycol as a solvent.

The ionic liquid includes at least one ionic salt and exists. The ionic slat comprises a cation and an anion and can exist in the liquid state at 100° C. or lower. Preferably, the cation is selected from the group consisting of dimethylimidazolium, ethylmethylimidazolium, diethylimidazolium, ethyldimethylimidazolium, butylmethylimidazolium, butylethylimidazolium, dibutylimidazolium, hexylmethylimidazolium, methylpyrrolidinium, dimethylpyrrolidinium, ethylmethylpyrrolidinium, methylpiperidinium, methylpiperidinium, methylmorpholinium, ethylmethylmorpholinium, N,N-dimethylformamidium, N,N-diethylformamidium, N,N-diisopropylformamidium, N,N-dibutylformamidium, N,N-dimethylacetamidium, N,N-diethylacetamidium, N,N-dimethylpropionamidium, N,N-dimethylbenzamidium, N,N-diethylbenzamidium, 1-formylpiperidinium) and N-methylpyrrolidonium, and the anion is selected from the group consisting of methylphosphite, dimethylphosphate, ethylphosphite, diethylphosphate, butylphosphite, dibutylphosphate, methylsulfate, ethylsulfate, acetate, trifluoroacetate, propionate, butanoate, hexanoate, benzoate, hexafluorophosphate, tetrafluorophosphate and trifluoromethenesulfonate. The content of the ionic liquid in the carbon dioxide absorbent of the present invention is preferably in the range from about 2 to 40 wt %, more preferably from about 5 to 20 wt %. If the content is lower than 2 wt %, there is a problem of increasing a regeneration temperature of the absorbent, while if it exceeds 40 wt %, there are problems of reducing CO₂ absorbing capacity of the absorbent under low pressure and increasing manufacturing costs thereof.

Amine is a compound in which a hydrogen atom of ammonia (NH₃) is replaced by a hydrocarbon residue R (e.g., alkyl or aryl group). The carbon dioxide absorbent according to the present invention includes at least one of a primary amine (R—NH₂), a secondary amine (RR′—NH), a tertiary amine (RR′R″N), a monoamine having one amine nitrogen atom such as aromatic amines and aliphatic amines, a diamine having 2 amine nitrogen atoms, a triamine having 3 amine nitrogen atoms, and a tetraamine having 4 amine nitrogen atoms. Suitable examples of the amine for the present invention include monoethanolamine, diethanolamine, triethanolamine, methylmonoethanolamine, methyldiethanolamine, dimethylmonoethanolamine, diethylmonoethanolamine, monoisopropanolamine, diisopropanolamine, piperazine, 1-methylpiperazine, dimethylpiperazine, 1-ethylpiperazine, 1-(2-aminoethyl)piperazine, 1-(2-hydroxyethyl)piperazine, 2-piperidinemethanol, 2-piperidineethanol, 2-amino-2-methyl-1-propanol, 2-amino-2-methyl-butanol, 2-amino-2-ethyl-1-propanediol, 3-aminopropanol, 2-ethylaminoethanol, 2-methylaminoethanol, 2-diethylaminoethanol and mixtures thereof. The content of amine in the carbon dioxide absorbent of the present invention is preferably in the range from about 5 to 50 wt %, more preferably from about 20 to 40 wt %. If the content is lower than 5 wt %, there is a problem of reducing CO₂ absorbing capacity of the absorbent under low pressure, while if it exceeds 50 wt %, there is a problem of increasing a regeneration temperature of the absorbent.

Glycol is a diol containing two hydroxyl groups (—OH), wherein each of the hydroxyl groups shows the properties of alcohol. The carbon dioxide absorbent according to the present invention includes at least one of a primary alcohol, a secondary alcohol and a tertiary alcohol. Suitable examples of the glycol for the present invention include ethylene glycol, propylene glycol, diethylene glycol, triethylene glycol, dipropylene glycol, hexylene glycol, butylene glycol and mixtures thereof. The content of glycol in the carbon dioxide absorbent of the present invention is preferably in the range from about 30 to 70 wt %. If the content is lower than 30 wt %, there is a problem of increasing a regeneration temperature of the absorbent, while if it exceeds 70 wt %, there is a problem of reducing CO₂ absorbing capacity of the absorbent.

In another aspect, the present invention provides a method of absorbing carbon dioxide by using the carbon dioxide absorbent. Generally, the absorption of carbon dioxide is increased proportionally as the temperature is decreased and the pressure is increased. According to the method of the present invention, the absorption is carried out at a temperature from about −20 to 80° C., preferably from about 20 to 50° C. under a pressure from about 1 to 100 atm, preferably from about 1 to 30 atm. If the temperature and pressure conditions deviate from the range described above, there is a problem in that the cost for operating the absorption process is excessively increased, and thereby, its absorption efficiency is reduced. Therefore, the carbon dioxide absorbent of the present invention is preferably used in the above-mentioned range. Further, in case of regenerating the carbon dioxide absorbent by degassing carbon dioxide therefrom, it is carried out at a temperature from about 20 to 120° C., preferably from about 40 to 80° C. under a pressure from about 0.01 to 20 atm, preferably from about 0.1 to 1 atm.

When compared to 30 wt % of a diethanolamine (MEA) solution industrially used as an absorbent in the art, the carbon dioxide absorbent of the present invention can lower the regeneration temperature by approximately 40° C. or higher, which results in the reduction of energy consumption by approximately 30% or more. In addition, while it is possible to reduce the loss of an absorbent due to deterioration by about 50% or more, the CO₂ absorption capacity of the regenerated absorbent can be increased by about 10% or more. Therefore, the carbon dioxide absorbent of the present invention can be effectively used for a process of collecting carbon dioxide from exhaust gas and natural gas and separating the same.

Specific embodiments of the present invention are illustrated by way of the following examples. This invention is not confined to the specific limitations set forth in these examples.

### EXAMPLE

### Preparation Example 1

1-Methylimidazole (SAMCHUM Chemical) 8.2 g (0.1 mole) was added to a 250 mL 3-neck flask equipped with a reflux condenser and a thermometer, and 12.1 g (0.11 mole) of dimethylphosphite (Sigma Aldrich) was gradually added drop by drop thereto at 50° C. After the dropping of dimethylphosphite was completed, the mixture was heated to 90° C. and stirred for 12 hours. After cooling to room temperature, the resulting product was washed with diethyl ether (Sigma Aldrich) three times, and subjected to vacuum drying at 50° C. for 4 hours so as to remove volatile substances including unreacted materials, to thereby obtain dimethylimidazolium methylphosphite ([DMIM][MHPO₃])(yield 96%).

### Preparation Example 2

The reaction was carried out according to the same method as described in Preparation Example 1 except that instead of dimethylphosphite, 16.9 g (0.11 mole) of diethylsulfate (Sigma Aldrich) was added drop by drop at room temperature, stirred for 2 hours, washed and subjected to vacuum drying, to thereby obtain ethylmethylimidazolium ethylsulfate ([EMIM][EtSO₄])(yield 96%).

### Example 1

To 40 g of ethylene glycol (EG, SAMCHUM Chemical) was added 24 g of monoethanolamine (MEA, SAMCHUM Chemical) and dissolved at 40° C. for 30 minutes or longer. Dimethylimidazolium methylphosphite ([DMIM][MHPO₃]) 16 g prepared in Preparation Example 1 was dissolved in the mixture at 40° C. for 30 minutes or longer, thereby obtaining 20 wt % [DMIM][MHPO₃]+30 wt % MEA+50 wt % EG as a carbon dioxide absorbent.

### Examples 2-4

To 52 g of ethylene glycol (EG) was added 24 g of diethanolamine (DEA, SAMCHUM Chemical) and dissolved at 40° C. for 20 minutes or longer. Ethylmethylimidazolium ethylsulfate ([EMIM][EtSO₄]) 4 g prepared in Preparation Example 2 was dissolved in the mixture at 40° C. for 30 minutes, thereby obtaining 5 wt % [EMIM][EtSO₄]+30 wt % DEA+65 wt % EG as a carbon dioxide absorbent (Example 2). According to the same method as described above, 10 wt % [EMIM][EtSO₄]+30 wt % DEA+60 wt % EG as a carbon dioxide absorbent (Example 3) was prepared with modifying the amounts of ethylene glycol and ethylmethylimidazolium ethylsulfate into 48 g and 8 g, respectively, and 20 wt % [EMIM][EtSO₄]+30 wt % DEA+50 wt % EG as a carbon dioxide absorbent (Example 4) was prepared with modifying the amounts thereof into 40 g and 16 g, respectively.

### Comparative Examples 1-4

In order to evaluate regeneration capacity of the carbon dioxide absorbent in accordance with the present invention, 24 g of monoethanolamine was added to 100 wt % of monoethanolamine (Comparative Example 1), water, ethylene glycol, and 56 g of dimethylimidazolium methylphosphite, respectively, and dissolved at 40° C. for 30 minutes or longer, to thereby obtain 30 wt % MEA+70 wt % H₂O (Comparative Example 2), 30 wt % MEA+70 wt % EG (Comparative Example 3), and 30 wt % MEA+70 wt % [DMIM][MHPO₃] (Comparative Example 4) as a carbon dioxide absorbent.

TABLE 1

| | |
|---|---|
| Example | Comparative Example |

| | 1 | 2 | 3 | 4 | 1 | 2 | 3 | 4 |
|---|---|---|---|---|---|---|---|---|
| [DMIM][MHPO₃] (wt %) | 20 | — | — | — | — | — | — | 70 |
| [EMIM][EtSO₄] (wt %) | — | 5 | 10 | 20 | — | — | — | — |
| MEA (wt %) | 30 | — | — | — | 100 | 30 | 30 | 30 |
| DEA (wt %) | — | 30 | 30 | 30 | — | — | — | — |
| EG (wt %) | 50 | 65 | 60 | 50 | — | — | 70 | — |
| H₂O(wt %) | — | — | — | — | — | 70 | — | — |

### Test Example 1

### Evaluation of Regeneration Capacity of an Absorbent

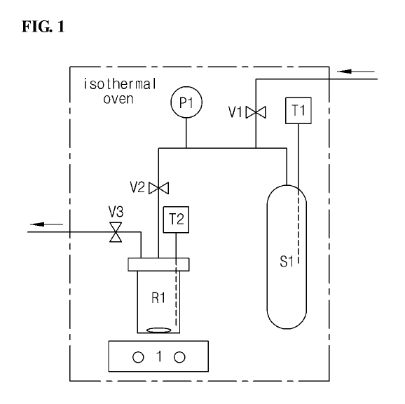

FIG. 1 is a diagram schematically illustrating an apparatus for evaluating CO₂ absorption-desorption capacity of an absorbent used in the removal of carbon dioxide. The CO₂ absorption apparatus was composed of a 60 ml stainless steel absorption container (R1) equipped with a thermometer (T2), a pressure gauge (P1), a 75 ml CO₂ storage cylinder (S1) equipped with a thermometer (T1) and a stirrer (1), and installed within an isothermal oven so as to evaluate CO₂ absorption-desorption capacity at a constant temperature.

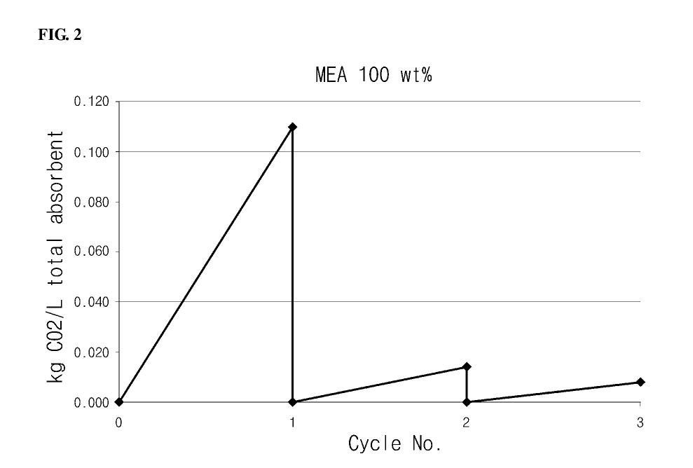

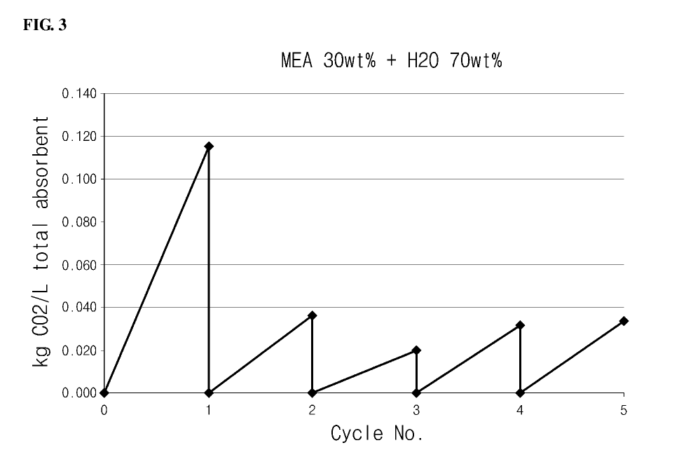

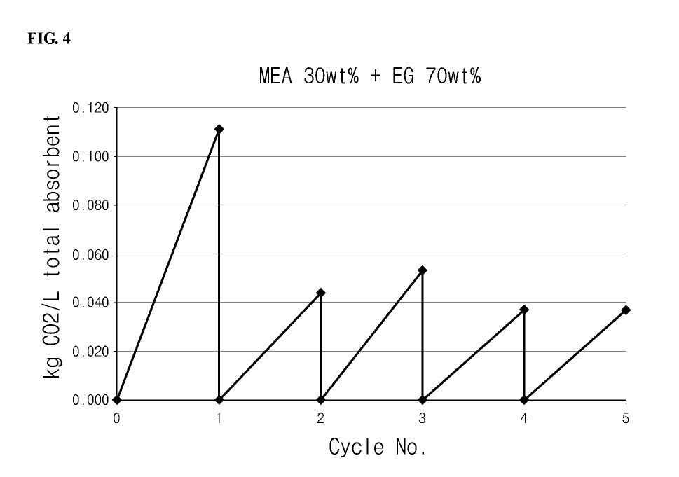

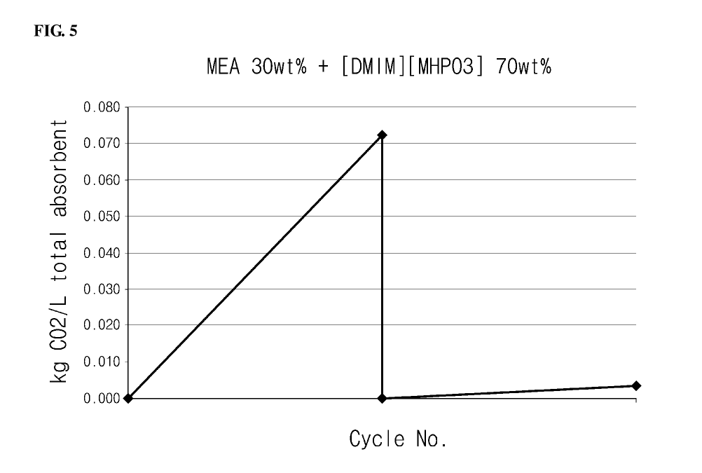

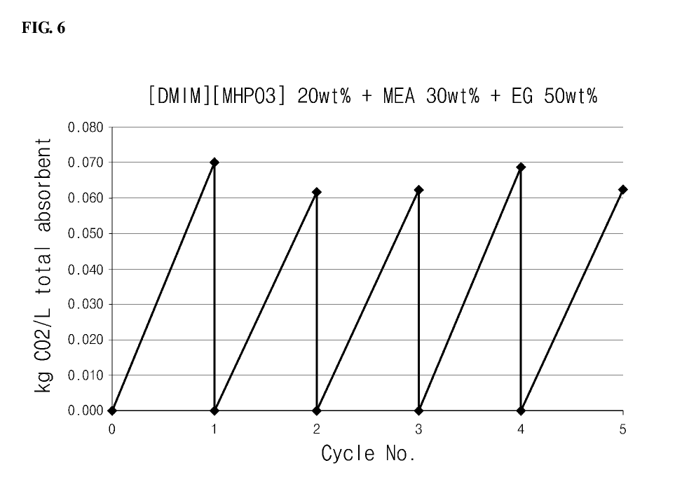

The test for assessing CO₂ absorption-desorption capacity was carried out as follows. After weighing the absorbent, it was put into the absorption container (R1) together with a bar magnet and vacuum-dried with stirring at 40° C. for 1 hour. After lacking a valve (V2) connected to the stainless steel absorption container (R1), 7 atm of carbon dioxide was injected into the CO₂ storage cylinder (S1), and the temperature and pressure at an equilibrium state were measured (initial value). Similarly, after opening the valve (V2), the temperature and pressure at an equilibrium state were measured, and the final temperature and pressure were measured after stirring for 30 minutes (equilibrium value). The degree of decreasing the pressure within the CO₂ storage cylinder was measured like this, and the amount of carbon dioxide absorbed was calculated by using the measured values according to the ideal gas equation. The regeneration of the absorbent was carried out as follows: the CO₂ absorption test was completed, the valve (V3) was opened, the pressure was reduced to 1 atm, and the absorbed carbon dioxide was degassed at 80° C. for 30 minutes, followed by vacuum degassing at 40° C. for 1 minute. After that, in order to evaluate the regeneration capacity of the absorbent, carbon dioxide was injected again at the same temperature and pressure as the previous absorption test (1 cycle), and this procedure was repeated several times. According to the method as described above, the regeneration capacities of the carbon dioxide absorbents prepared in Comparative Examples 1 to 4 were evaluated at 80° C., and the results are shown in FIGS. 2 to 5, respectively. Further, the regeneration capacity of the carbon dioxide absorbent prepared in Example 1 was also evaluated according to the same method, and the result is shown in FIG. 6.

As can be seen in FIGS. 2 to 5, it has been found that when regenerated at 80° C., the prior art carbon dioxide absorbents, 100 wt % MEA, 30 wt % MEA+70 wt % H₂O, 30 wt % MEA+70 wt % EG, and 30 wt % MEA+70 wt % [DMIM][MHPO₃] show significantly reduced regeneration capacities. In fact, in the CO₂ absorption process using an amine-based absorbent, the absorbent was regenerated at a high temperature from 110 to 140° C., and the energy expense required for such a regeneration process accounted for 50% or more of the total cost of CO₂ absorption.

In the case of the 20 wt % [DMIM][MHPO₃]+30 wt % MEA+50 wt % EG carbon dioxide absorbent in accordance with the present invention, MEA forms a carbamic acid by binding to CO₂, which converts into carbamate. It has been well known that according to the theoretical calculation, a rate determining step of the absorption process is the step that MEA receives a proton from carbamic acid. The noticeable thing is the fact that after the formation of carbamic acid, CO₂⁻ bound to the nitrogen atom of carbamate interacts with a hydroxyl group (—OH) and —NH₃⁺ of the protonated amine. Further, in case of using the ionic liquid together with EG as a mixed solvent, a cation and an anion of the ionic liquid, a hydrocyl group (—OH) of EG, the protonated amine and carbamate interact with each other, which results in destabilization of the protomated amine and carbamate. The destabilized carbamate can easily degas carbon dioxide even though it is heated at low temperature, and the stabilized protonated amine can easily release its proton at low temperature. As a result, as shown in FIG. 6, the regeneration capacity of the carbon dioxide absorbent according to the present invention was remarkably increased by 67% or higher as compared to the prior art absorbents when regenerated at 80° C., which makes possible to reduce energy consumption by lowering the regeneration temperature.

In addition, it has been found that the carbon dioxide absorbent according to the present invention shows excellent CO₂ absorption capacity under a pressure of 7 atm, and therefore, it can solve the problem of the prior art ionic liquid absorbents that their absorption capacity is considerably lowered under a low pressure from 1 to 15 atm.

### Test Example 2

### Regeneration Capacity of an Absorbent Depending on the Content of an Ionic Liquid

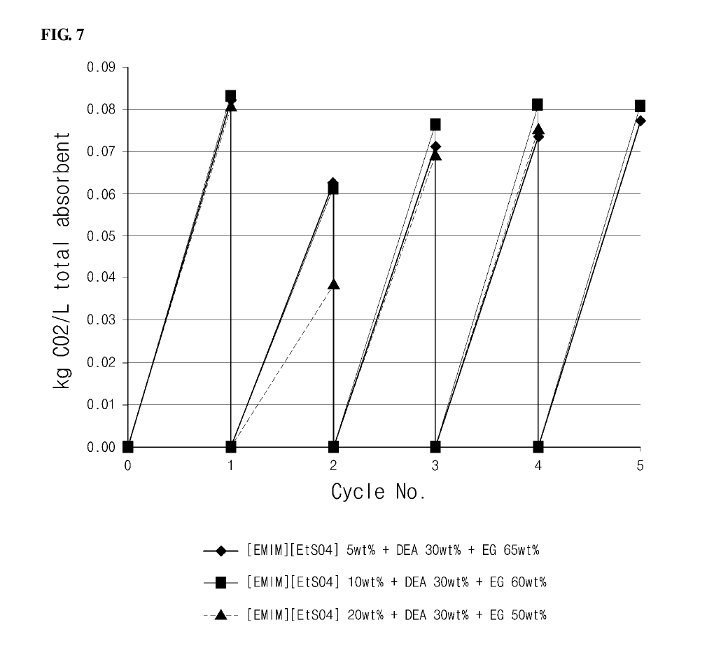

The carbon dioxide absorbents prepared in Examples 2 to 4 in accordance with the present invention were subjected to regeneration capacity test according to the same method as described in Test Example 1 except that the regeneration temperature was increased by 10° C. as the regeneration cycle was increased, i.e., the regeneration temperature of the first cycle was set at 60° C., that of the second cycle, at 70° C., that of the third cycle, at 80° C., and the forth cycle, at 90° C. The results are shown in FIG. 7.

As can be seen in FIG. 7, it has been found that the carbon dioxide absorbent containing 10 wt % [EMIM][EtSO₄] (Example 3) exhibits the best regeneration capacity, and in the absorbents containing 5 wt % (Example 2) and 20 wt % (Example 4) of [EMIM][EtSO₄], respectively, the reduction of CO₂ absorption capacity due to the repetitive regeneration is insignificant. Accordingly, with the present invention, the above-described prior art problem that it is required to continuously add a new absorbent to compensate the decrease in CO₂ absorption capacity during the regeneration process can be solved.

1. A carbon dioxide absorbent comprising an ionic liquid, an amine and a glycol.

2. The carbon dioxide absorbent according to claim 1, which comprises 2-40 wt % of the ionic liquid; 5-50 wt % of the amine; and 30-70 wt % of the glycol.

3. The carbon dioxide absorbent according to claim 1, wherein the ionic liquid includes one or more ionic salts, the ionic salt each being capable of existing in liquid at 100° C. or lower and comprising a cation and an anion, the cation being selected from the group consisting of dimethylimidazolium, ethylmethylimidazolium, diethylimidazolium, ethyldimethylimidazolium, butylmethylimidazolium, butylethylimidazolium, dibutylimidazolium, hexylmethylimidazolium, methylpyrrolidinium, dimethylpyrrolidinium, ethylmethylpyrrolidinium, methylpiperidinium, methylpiperidinium, methylmorpholinium, ethylmethylmorpholinium, N,N-dimethylformamidium, N,N-diethylformamidium, N,N-diisopropylformamidium, N,N-dibutylformamidium, N,N-dimethylacetamidium, N,N-diethylacetamidium, N,N-dimethylpropionamidium, N,N-dimethylbenzamidium, N,N-diethylbenzamidium, 1-formylpiperidinium and N-methylpyrrolidonium, and the anion being selected from the group consisting of methylphosphite, dimethylphosphate, ethylphosphite, diethylphosphate, butylphosphite, dibutylphosphate, methylsulfate, ethylsulfate, acetate, trifluoroacetate, propionate, butanoate, hexanoate, benzoate, hexafluorophosphate, tetrafluorophosphate and trifluoromethenesulfonate.

4. The carbon dioxide absorbent according to claim 1, wherein the amine is selected from the group consisting of monoethanolamine, diethanolamine, triethanolamine, methylmonoethanolamine, methyldiethanolamine, dimethylmonoethanolamine, diethylmonoethanolamine, monoisopropanolamine, diisopropanolamine, piperazine, 1-methylpiperazine, dimethylpiperazine, 1-ethylpiperazine, 1-(2-aminoethyl)piperazine, 1-(2-hydroxyethyl)piperazine, 2-piperidinemethanol, 2-piperidineethanol, 2-amino-2-methyl-1-propanol, 2-amino-2-methyl-butanol, 2-amino-2-ethyl-1-propanediol, 3-aminopropanol, 2-ethylaminoethanol, 2-methylaminoethanol, 2-diethylaminoethanol and mixtures thereof.

5. The carbon dioxide absorbent according to claim 1, wherein the glycol is selected from the group consisting of ethylene glycol, propylene glycol, diethylene glycol, triethylene glycol, dipropylene glycol, hexylene glycol, butylene glycol and mixtures thereof.

6. A process of absorbing carbon dioxide, comprising:
contacting a gas containing carbon dioxide with the carbon dioxide absorbent according to claim 1 at a temperature from about −20 to 80° C. under a pressure from about 1 to 100 atm;
degassing carbon dioxide at a temperature from about 20 to 120° C. under a pressure from about 0.01 to 20 atm.
